(19) United States
(12) Patent Application Publication
(10) Pub. No.: US 2006/0120502 A1
(43) Pub. Date: Jun. 8, 2006

(54) Nuclear reactor feed-water system

(75) Inventors: Hiroaki Tomiki, Yokohama-shi (JP); Takeo Asaka, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/006,685

(22) Filed: Dec. 8, 2004

(51) Int. Cl. G21C 19/28

(52) U.S. Cl. 376/402

(57) ABSTRACT

In a reactor feed-water system in which water is fed to a reactor pressure vessel by at least one reactor feed-water pump, a driving power for a feed-water pump drive motor is supplied from a semiconductor power conversion circuit adopting a self-excitation switching device; a reactor water-level detection value, a main steam flow rate detection value and a rector feed-water flow rate detection value are calculated by adding or subtracting these values; and a comparison result between the result of the calculation and a reactor water-level setting signal is given, as current command value to an inverter, to the inverter of the semiconductor power conversion circuit, thereby controlling the revolution number and torque of the feed-water pump drive motor, thus controlling the reactor feed-water flow rate.

### BACKGROUND OF THE INVENTION

1. Field of The Invention

The present invention relates to a nuclear reactor feed-water system of a nuclear power plant, and more particularly, to a nuclear reactor feed-water system utilizing a semiconductor power conversion circuit as a power source of a feed-water pump drive motor.

2. Related Art

A known nuclear reactor feed-water system adopted for an existing nuclear power plant will be first explained with reference to FIGS. 11 and 12.

FIG. 11 is a schematic diagram of a nuclear reactor feed-water system utilized in a known technology, and FIG. 12 is a structural block diagram of a reactor feed-water pump control device.

With reference to FIG. 11, the reference numeral 1 denotes a pressure vessel of a nuclear reactor and the reference numeral 2 denotes a re-circulation pump. A main steam generated in the pressure vessel 1 is fed to a steam turbine 4 through a main steam stop valve 3 and a steam control valve, not shown, and the steam is expanded in the steam turbine 4 to thereby rotate the steam turbine. Thereafter, the main steam is condensed in a capacitor 5 into condensate. This condensate is pressurized by a nuclear reactor feed-water pump unit 7 and then fed into the pressure vessel 1. A turbine generator 6 is directly coupled to the steam turbine by means of turbine shaft.

The reactor feed-water pump unit 7 mentioned above includes two kinds of pumps, i.e., one being a turbine drive nuclear reactor feed-water pump 8 (called hereinlater “turbine drive feed-water pump 8) which is driven by a turbine 8T and the other one being a motor drive nuclear reactor feed-water pump 9 (called hereinlater “motor drive feed-water pump 9) which is driven by a motor 9M. In an alternation, however, a nuclear power plant may be equipped only with the motor drive feed-water pump 9.

In the case of the turbine drive feed-water pump 8, feed water flow rate is controlled by regulating the speed of the feed-water pump 8 by the turbine 8T, and on the other hand, in the case of the motor drive feed-water pump 9, the feed-water pump 9 is driven at a constant speed by the motor 9M and the feed water flow rate is controlled by regulating the degree of opening of a feed-water regulating valve 10 disposed on an outlet side of the power plant.

Further, a nuclear reactor feed-water pump control unit 11 generates feed water flow rate commands to the turbine 8T and the feed-water regulating valve 10. In FIG. 11, the reference numerals 12 and 13 denote a speed control circuit 12 of the turbine drive feed-water pump 8 and a control circuit 13 of the feed-water regulating valve 10, respectively, which will be explained hereinafter with reference to FIG. 12.

The reactor feed-water pump control unit 11 is explained hereunder with reference to FIG. 12.

The reactor feed-water pump control unit 11 includes a reactor water-level detector 14 for detecting reactor water level, a main steam flow rate detector 15 for detecting the flow rate of the main steam, and a feed-water flow rate detector 16 for detecting the reactor feed-water flow rate. These detectors 14, 15 and 16 generate water level detecting signals 14s, main steam flow rate signals 15s, and feed-water flow rate signals 16s, which are then inputted into an addition/subtraction operating unit 17, in which these signals are processed and feed-water flow rate request signals 17s are operated.

Moreover, the feed-water pump control unit 11 includes a three-function/single-function change-over switch 18 for switching an input signal in response to a fact that the feed-water control is performed with three functions (reactor water level, main stream flow rate, reactor feed-water flow rate) or single function (reactor water level). In the case of the single-function control, the feed-water flow rate demand signal in response to the water-level detection signal 14s inputted from the water level detector. 14 is selectively outputted, and on the other hand, in the case of the three-function control, the feed-water flow rate demand signal 17s calculated by operating three-function detection signals is selectively outputted. An output signal 18s from the three-function/single-function change-over switch 18 is inputted into the water-level controller 19, which is then compared with a reactor water-level set value 20s of the reactor water-level setter 20. The water-level controller 19 generates a feed-water flow rate command value 19s so as to accord with the reactor water-level set value 20s. The afore-mentioned turbine drive feed-water pump speed control circuit 12 and the feed-water regulation valve control circuit 13 perform turbine revolution (number) control and valve-opening degree control of the regulation valve in response to the feed-water flow rate command value 19s, thus controlling the reactor feed-water flow rate (for example, refer to Japanese Patent Laid-open (KOKAI) Publiation No. HEI 5-15789 and No. HEI 6-308288)

However, the feed-water flow rate control by using the feed-water regulation valve 10 disposed at the outlet of the motor drive feed-water pump 9 of the conventional structure mentioned above involves the following fears.

(1) In the case of small value of the feed-water flow rate command, the motor 9M continues a rated operation and regulates the flow rate in accordance with the degree of opening of the feed-water regulation valve 10, so that, even in a case of a small amount of actual flow rate, the motor 9M consumes a power at the time of the rated operation, i.e., power more than that corresponding to the feed-water amount, thus constituting one factor of obstructing effective use of the power in the plant.

(2) Variation range of the reactor water level is determined depending on a demand in safety of the reactor and function of a gas-water separator, not shown. However, there is a fear that, by a desensitizing zone of the fed-water regulation valve 10, the feed-water flow rate causes hunching phenomenon and variation in the reactor water level, so that it becomes difficult to maintain a suitable set water level of the reactor water.

(3) The characteristic of the water feed to the reactor due to erosion of the feed-water regulation valve 10 may vary, and accordingly, there is a fear of not obtaining predetermined reactor water level, and it becomes difficult to maintain the set water level.

### SUMMARY OF THE INVENTION

The present invention was conceived in consideration of the above matters encountered in the prior art and an object of the present invention is to provide a nuclear reactor feed-water system capable of keeping a stable reactor water level by controlling the reactor feed-water by using a motor driven type feed-water pump without using a feed-water regulating valve and capable of suppressing a power consumption more than necessity of the pump drive motor.

A nuclear reactor feed-water system provided for achieving the above object in which water is fed to a reactor pressure vessel by a reactor feed-water pump, comprises:

a current command value operating unit for comparing a reactor water level setting signal setting a reactor water-level in a reactor pressure vessel with either one of a signal obtained by adding or subtracting a reactor water level detection value, a main steam amount flow rate detection value of a flow rate of the main steam introduced into a steam turbine from the reactor pressure vessel, and a reactor feed-water flow rate detection value of an amount of feed-water fed to the reactor pressure vessel, or reactor water-level detection value, and operating and then outputting a current command value based on comparison result;

a revolution/torque operating unit for operating revolution number command value and toque command value of the reactor feed-water pump in response to the current command value inputted in the revolution/torque operating unit; and

a semiconductor power conversion circuit for supplying power of variable frequency by an inverter with respect to at least one feed-water pump drive motor driving the reactor feed-water pump,

wherein the feed-water drive motor is controlled by giving the revolution umber command value and the torque command value to the inverter to thereby control the feed-water flow rate to the reactor pressure vessel.

In preferred embodiments or examples, it may be desired that a plurality of feed-water drive motors are arranged, and a control object switching means for selecting an optional feed-water pump drive motors in accordance with the current command value.

A by-pass line may be disposed between inlet side and out side of the motor drive feed-water pump to thereby ensure water-passing in a low-speed area at a motor drive feed-water pump operation start time through the by-pass line.

The nuclear reactor feed-water system may further comprise: a load current detecting means for detecting a current passing through the feed-water pump drive motor; a revolution number detecting means for detecting revolution numbers of the feed-water pump drive motor; a calculating means for calculating a deviation between the current command value and the load current detection value; and a pulse width modulation switching pattern circuit inputting the deviation and the revolution number detection value, wherein a self-excitation switching device constituting an inverter of the semiconductor power conversion circuit is controlled to be “on” or “off” in response to a signal outputted from the pulse width modulation switching pattern circuit.

The nuclear reactor feed-water system may further comprise a vector control operator inputting the current command value and the revolution number detection value, wherein a deviation between an output from the vector control operator and the loaded current is inputted into the pulse width modulation switching pattern circuit, and a self-excitation switching device constituting an inverter of the semiconductor power conversion circuit is controlled to be “on” or “off” in response to a signal outputted from the pulse width modulation switching pattern circuit. A revolution speed operator for calculating a revolution speed by inputting a load current detection value from the pump drive motor may be further provided, wherein an output of the revolution speed operator is inputted into the vector control operator in place of the revolution number detection value.

It may be desired that the vector control operator serves to zero-control a torque current component of the motor at an instantaneous power stop period of the power source system or line and to control an excitation current component of the motor to a rated value.

It may be further desired that a converter of the semiconductor power conversion circuit is constituted by a self-excitation switching device, and further comprising: a phase locked loop circuit for preparing a current command from a voltage detected from a power source line side of the semiconductor power conversion circuit and a voltage from a DC smoothing capacitor; and a pulse width modulation control circuit for comparing a current detected from the power source line side with a current command value outputted from the phase locked loop circuit.

Furthermore, it may be desired that a low-order higher harmonic wave and a power source capacity are reduced by input side power factor “1” control of the semiconductor power conversion circuit through detection of a power source line side voltage and current in a converter circuit as an input side of the semiconductor power conversion circuit and a DC smoothing capacitor voltage of the converter, and a power supply to a line side at a speed reduction/stop time of the pump drive motor of a load power is enabled in addition to a power supply to the pump drive motor side of the converter circuit, or a regenerative power consumption in the inverter/converter circuit is enabled by controlling the current phase.

As mentioned above, according to the present invention, at the time of controlling the feed water flow rate from the motor driving feed-water pump in the nuclear reactor feed-water system, the semiconductor power conversion circuit having the inverter in place of the flow rate regulation valve is arranged, the inverter being controlled in response to the current command, to thereby control the revolution/torque of the feed-water pump drive motor. Accordingly, the motor can be operated in conformity with the feed-water flow rate requirement. Hence, in comparison with the operation at the rated speed as in the conventional technology, the power is not consumed more than necessity, and in addition, hunching, erosion or like adverse phenomenon, which may be caused by the use of the flow rate regulation valve, can be prevented from occurring and the stable reactor water-level controlling can be achieved.

Furthermore, according to one preferred embodiment of the present invention, the low order high harmonic wave component contained in the current value on the power source line side can be suppressed, so that the high harmonic wave current leakage towards the power source line side can be significantly reduced. In addition, by regulating the input power factor to “1”, the reactive power on the input side becomes zero and, hence, the active power equals to the same value as the apparent power, thus reducing the capacity of the power source of the present system. Moreover, it becomes possible to make effective the recovery operation for returning the active power component generated at the speed reduction or stop period of the pump drive motor to the power system or line side, thus enabling the effective utilization of the power. In this recovery operation, it may be possible to locate the open/close switch and the discharge resistor between the inverter and the converter without returning the power to the power system side so as to consume the recovery power from the motor side by this discharge resistor. In such case, it is possible to constitute the rectifier using the diode element without using the self-excitation switching device of the converter circuit, thus making simple and compact the circuit arrangement and controlling mode.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a structural diagram of a nuclear reactor feed-water system according to a first embodiment of the present invention;

FIG. 2 is a block diagram of a nuclear reactor feed-water pump control unit in the first embodiment of the present invention;

FIG. 3 is a circuit diagram of a power source of a pump drive motor in the first embodiment of the present invention;

FIG. 4 is a block diagram of a nuclear reactor feed-water pump control unit in a second embodiment of the present invention;

FIG. 5 is a block diagram of a nuclear reactor feed-water pump control unit in a third embodiment of the present invention;

FIG. 6 is a block diagram of a nuclear reactor feed-water pump control unit and a power source of a pump drive motor in a fourth embodiment of the present invention;

FIG. 7 is a block diagram of a nuclear reactor feed-water pump control unit and a power source of a pump drive motor in a fifth embodiment of the present invention;

FIG. 8 is a block diagram of a nuclear reactor feed-water pump control unit and a power source of a pump drive motor in a sixth embodiment of the present invention;

FIG. 9 is a block diagram of a nuclear reactor feed-water pump control unit and a power source of a pump drive motor in a seventh embodiment of the present invention;

FIG. 10 is a circuit diagram of a power source of a pump drive motor in an eighth embodiment of the present invention;

FIG. 11 is a diagram showing a conventional nuclear reactor feed-water system; and

FIG. 12 is a block diagram of a conventional nuclear reactor feed-water control unit.

### DESCRIPTION OF THE PREFERRED EMBODIMENT

Preferred embodiments of the present invention will be described hereunder with reference to the accompanying drawings, in which same or like reference numerals are added to the same or common units, members of the respective drawings of the present invention and the prior art.

### First Embodiment

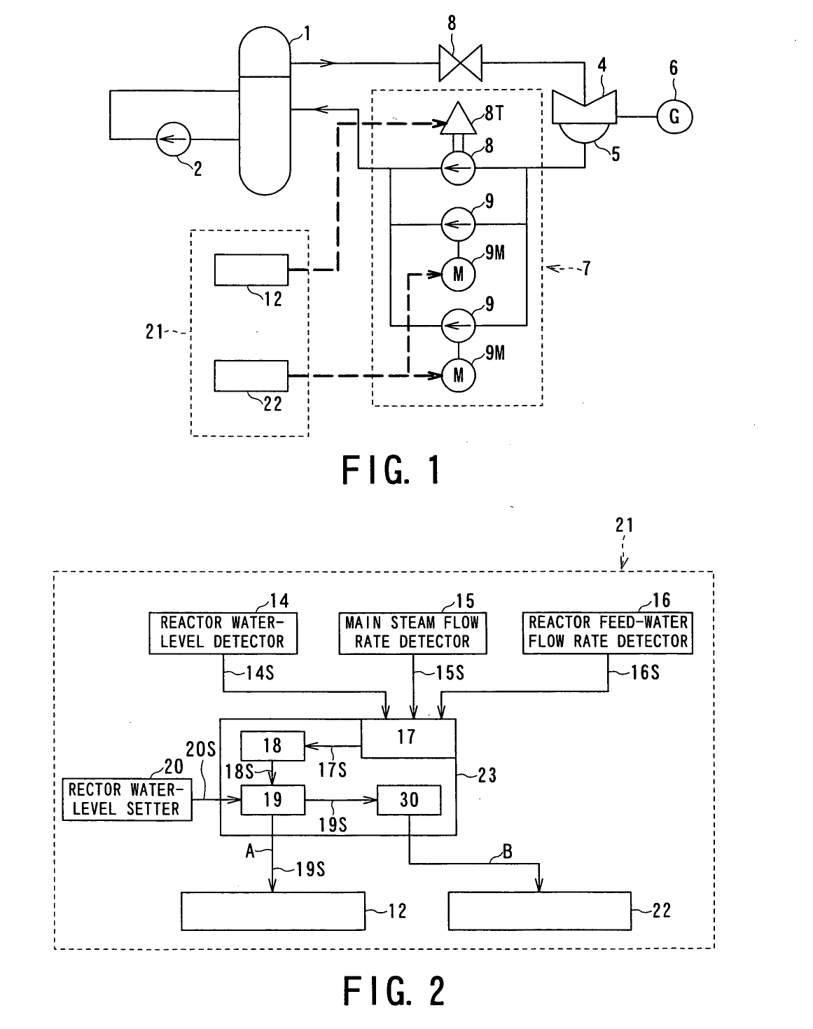

A reactor feed-water system according to the first embodiment will be described with reference to FIGS. 1 to 3.

The nuclear reactor feed-water system of this first embodiment basically differs from the conventional technology mentioned hereinbefore in the point that the feed-water pump drive motor 9M is driven by a semiconductor power conversion apparatus, for generating variable frequency and variable voltage, in place of the reactor feed-water regulation valve 10 in the conventional structure.

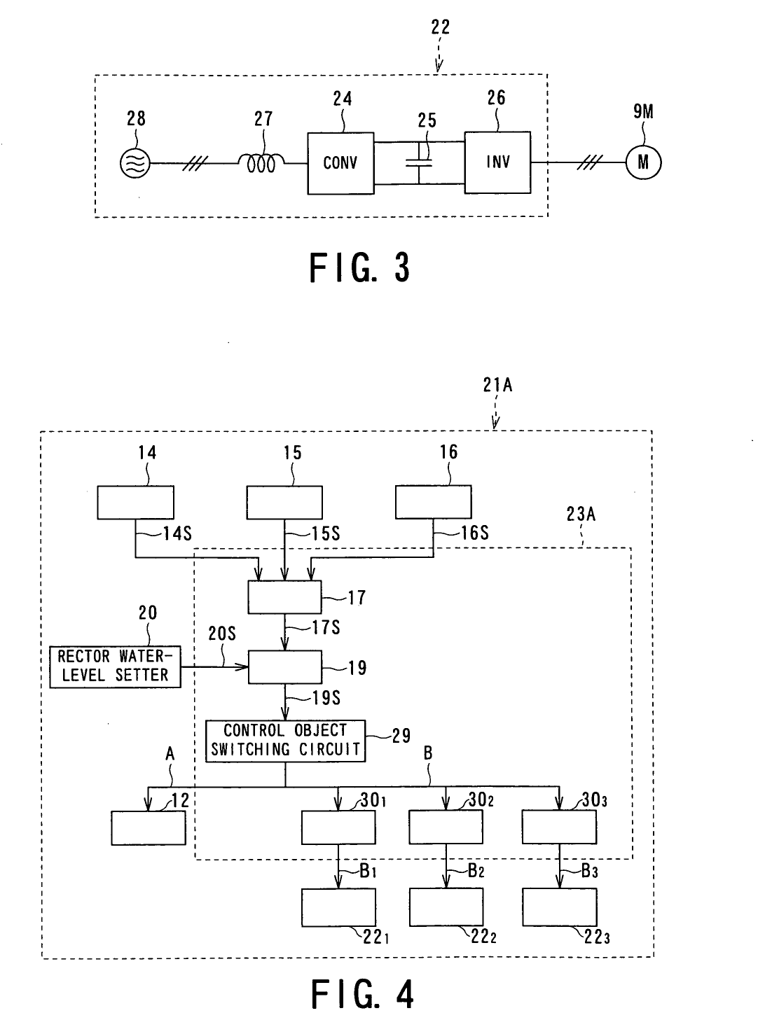

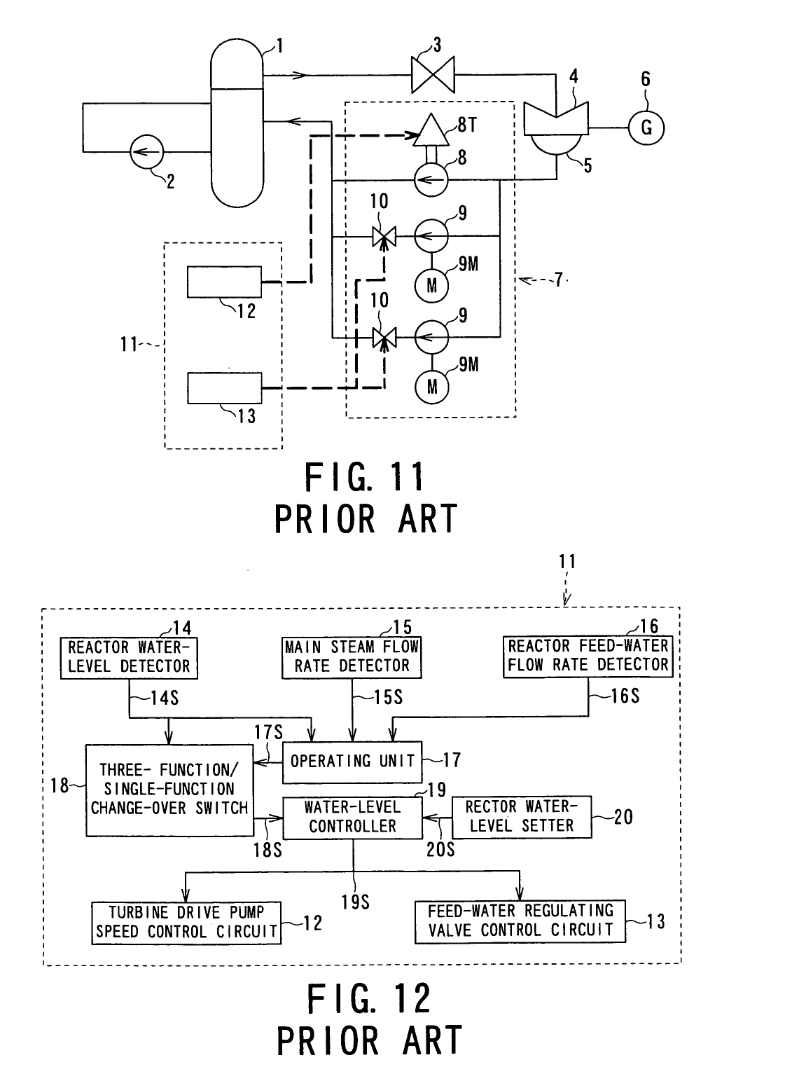

With reference to FIG. 1, a reactor feed-water pump control unit 21 is newly disposed in place of the conventional reactor feed-water pump control unit 11, and a semiconductor power conversion circuit 22 including an inverter is also disposed in place of the feed-water regulation valve control circuit 13 so as to make variable the output frequency and output voltage by a trigger signal given to a switching device constituting the inverter. The details of such semiconductor power conversion circuit 22 will be explained hereunder with reference to FIG. 3. Structures of this first embodiment of FIG. 1 other than that mentioned above is substantially identical to those of the conventional structure of FIGS. 11 and 12, so that the details thereof are now omitted herein.

The nuclear reactor feed-water pump control unit 21 will be described hereunder with reference to FIG. 2. This nuclear reactor feed-water pump control unit 21 differs from that of the conventional structure mentioned hereinbefore (FIGS. 11 and 12) in that the feed-water pump drive motor 9M is driven by a semiconductor power conversion circuit 22 which is disposed as a drive source of the feed-water pump drive motor 9M in substitution for the reactor feed-water regulation valve control circuit 13. According to such substitution, the addition/subtraction operator 17, the three-function/single-function change-over switch 18 and the water-level controller 19, and a revolution/torque operating circuit 30 giving revolution/torque command to the semiconductor power conversion circuit 22 are integrated as one control-operation circuit 23. However, such integration is not an essential requirement for the present invention.

Although the feed-water flow rate command valve 19s obtained by comparing and operating the output 18s of the three-function/single-function change-over switch 18 and reactor water level set value 20s in the water-level controller 19 was referred to as feed-water flow rate demand signal in the conventional art, it may be referred to hereunder as an inverter current command valve in the present invention.

The control-operation circuit 23 has a function for outputting a speed command A to the turbine drive feed-water pump speed control circuit 12 and, in addition, outputting a revolution command/torque control command B of the feed-water pump drive motor 9M to the semiconductor power conversion circuit 22 by the revolution-number/torque operation circuit 30. Structures other than the above are substantially identical to those of FIG. 12, so that the details thereof are omitted herein.

The semiconductor power conversion circuit 22 will be then described hereunder with reference to FIG. 3.

The semiconductor power conversion circuit 22 mainly includes a converter (CONV) 24 to which a diode is connected in three-phase bridge form and an inverter (INV) 26 to which a DC smoothing capacitor 25 and a self-exciting type semiconductor switching device such as thyristor are connected in three-phase bridge form, and a power source line side terminal of the converter 24 is connected to a house (plant) power source 28 through a reactor 27. The feed-water pump drive motor 9M functions and is operated in accordance with the frequency and torque responding to the feed-water flow rate command value by applying the trigger signal in response to the current command value to the switching device of the inverter 26.

As mentioned above, the feed-water pump drive motor 9M is driven by the output of the inverter 26 in response to the feed-water flow rate command, and then, the motor drive feed water pump 9 operates to feed the water to the reactor pressure vessel 1 as instructed by the feed-water flow rate command.

As mentioned above, in the nuclear reactor feed-water system of the embodiment described above, the feed-water pump drive motor 9M is driven by the output of the inverter 26 in response to the feed-water flow rate command value without using the feed-water regulation valve 10, so that there is no such a fear as that the feed-water flow rate may be subjected to hunting by the desensitizing area of the feed-water regulation valve 10 as in the prior art and the feed-water characteristic to the reactor may vary due to erosion of the feed-water regulation valve 10. Furthermore, since the feed-water pump drive motor is variably operated in accordance with the required feed-water amount, the power is not consumed more than required in comparison with the case of the rated speed operation in the conventional technology.

In addition, the calculation of the detecting values and the water-level control performed by the conventional technology are executed in the control-operation circuit 23, so that the control operation efficiency can be improved.

Further, although, in the present specification, the nuclear reactor feed-water pump control unit 21 has been described, for the sake of explanation, with reference to the case in which an object to be controlled is one set of feed-water pump drive motor 9M and the semiconductor power conversion circuit 22 as the driving source of the feed-water pump drive motor 9M, in a case of a plurality of objects to be controlled, it is necessary to additionally incorporate a control object switching circuit. This technical matter will be applicable to all the embodiments other than the following second embodiment which will be mentioned hereinlater.

### Second Embodiment

FIG. 4 shows a block diagram representing the nuclear reactor feed-water pump control unit according to the second embodiment of the present invention.

The embodiment relates to the nuclear reactor feed-water pump control unit provided with a plurality of objects to be controlled (three, for example), and a control object switching circuit is additionally disposed in the control-operation circuit 23A, which is operated as a master control unit to carry out total control without disposed a plurality of units corresponding to the motor drive feed-water pumps 9. Further, in this and following embodiments, the three-function/single-function change-over switch is eliminated for the sake of easy explanation.

With reference to FIG. 4, reference numeral 21A denotes a nuclear reactor feed-water pump control unit, and reference numeral 29 denotes a control object switching circuit acting to select the motor driven feed-water pump 9 or turbine drive feed-water pump speed control circuit 12 in response to the feed-water flow rate command value 19s outputted from the water-level controller 19. In addition, this control object switching circuit 29 gives the feed-water flow rate command value 19s, in a case of much feed-water flow rate, to the revolution/torque control operation circuits 30₁ to 30₃ so as to operate a plurality of motor drive feed-water pumps 9, and on the other hand, in a case of small feed-water flow rate, to one revolution/torque control operation circuits 30₁ (or 30₂, 30₃) by selectively switching a plurality of motor drive feed-water pumps 9.

The wait information of the secondary motor drive feed-water pump is preliminarily registered to the control object switching circuit 29 or inputted on line, and furthermore, in an occurrence of abnormality of the motor drive feed-water pump 9 during its operation, a detected result of such abnormality is also inputted thereinto.

The revolution/torque control operation circuits 30₁ to 30₃ acts to operate or calculate revolution umber instructions and torque instructions B₁ to B₃ in response to the current command from the control object switching circuit 29 and then to give trigger signals to the semiconductor power conversion circuits 22₁ to 22₃ connected respectively thereto. Further, as mentioned above, since the wait information of the secondary motor drive feed-water pump is preliminarily registered to the control object switching circuit 29 or inputted on line, in an occurrence of abnormality of the motor drive feed-water pump 9 during its operation, the waiting secondary motor drive feed-water pump 9 can be driven.

According to the second embodiment of the structure mentioned above, the following effects would be achieved.

(1) The units or members to be controlled such as nuclear reactor water-level detectors 14 and feed-water flow rate detectors 16 of a plurality of motor drive feed-water pumps 9 can be managed and controlled at one section, so that the entire system can be made compact in structure.

(2) When a plurality of motor drive feed-water pumps 9 are driven parallelly under the small feed-water flow rate, the feed-water drive motors 9M are driven at light load condition, thus providing no effective operating condition and, thus, being not economical. According to this embodiment, the feed-water pump drive motors 9M of the numbers in accordance with the necessary flow rate are operated, thus controlling the flow rate and hence reducing the power to be consumed in the plant.

(3) As like in the above (2), when a plurality of feed-water pump drive motors 9M are driven parallelly under the small feed-water flow rate, the switching loss, of a degree in accordance with the numbers of the circuits, is caused in the switching device of the semiconductor power conversion circuit 22. According to this embodiment, in order to suppress the switching loss as much as possible, in the case of the small feed-water flow rate, the feed-water pump drive motor 9M to be operated can be selected so as to control the feed-water flow rate, thereby reducing the total switching numbers and reducing the consumed power in the plant.

(4) In a case where the operation of the reactor feed-water pump 9, now driven, is stopped unexpectedly by a certain accident, the waiting secondary pump is driven, thus improving the operational condition.

### Third Embodiment

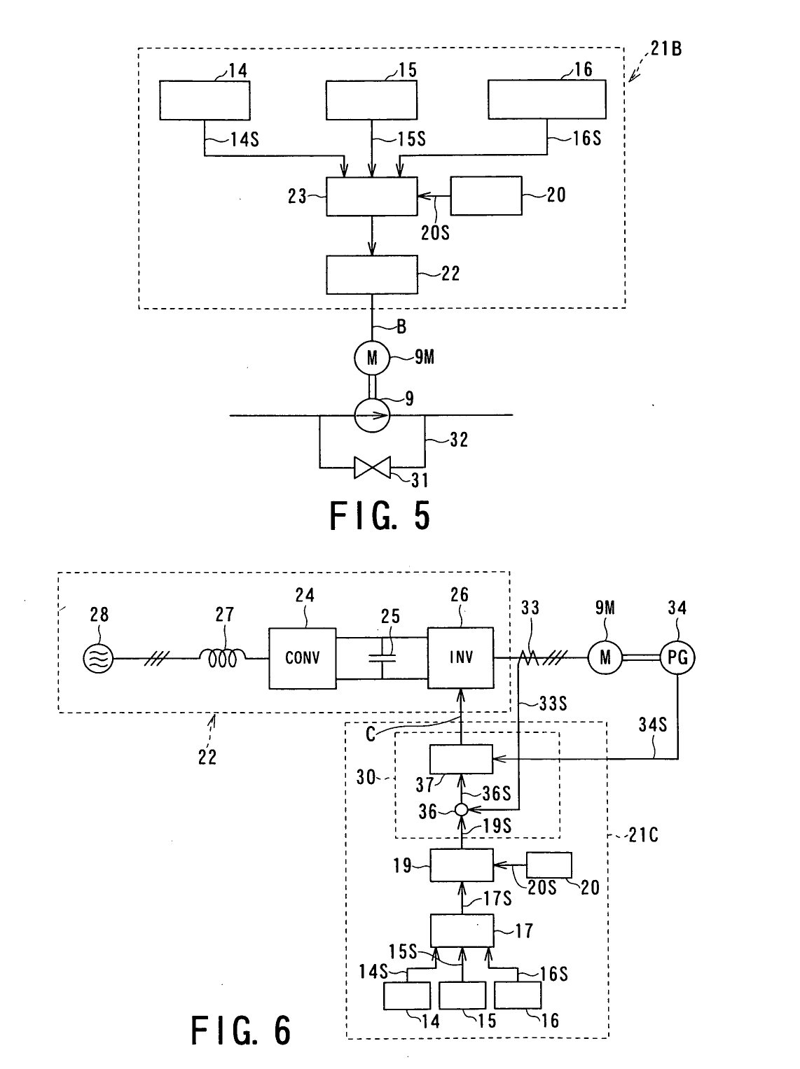

FIG. 5 shows a block diagram representing the nuclear reactor feed-water pump control unit according to the third embodiment of the present invention.

With reference to FIG. 5, reference numeral 21B denotes a nuclear reactor feed-water pump control unit according to this third embodiment, in which the turbine drive feed-water pump speed control circuit 12 is eliminated. In the third embodiment, a by-pass conduit or line 32 provided with a by-pass valve 31 is connected between the inlet side and the outlet side of the motor drive feed-water pump 9 in the reactor feed-water pump control unit in the above first or second embodiment. In the controlling of the feed-water drive motor 9M utilizing the semiconductor power conversion circuit 22, if it is difficult to ensure the minimal flow rate in a low speed area at the driving time, the by-pass valve 31 of the by-pass line 32 could be opened only in the area to achieve a certain degree of speed at the driving operation stating time.

As a result, even in a case where it is difficult to ensure the minimal flow rate at the driving operation starting time of the motor drive feed-water pump 9, the reactor feed-water system never fall in water feed impossible state.

### Fourth Embodiment

FIG. 6 shows a block diagram representing the nuclear reactor feed-water pump control unit according to the fourth embodiment of the present invention.

With reference to FIG. 6, reference numeral 21C denotes a nuclear reactor feed-water pump control unit, in which the turbine drive feed-water pump speed control circuit 12 is eliminated. In this fourth embodiment, in the semiconductor power conversion circuit 22 mentioned with reference to the first, second and third embodiments, a load current detector 33 is provided for the main circuit which connects the inverter 26 and the feed-water pump drive motor 9M to detect a load current flowing the motor 9M, and a rotational (revolution) speed detector 34 is also provided for the motor 9M to detect the revolution speed, whereby detected current value 33s and detected revolution number 34s are then inputted into the aforementioned revolution/torque control operation circuit 30.

In FIG. 6, reference numeral 36 denotes a comparator comparing the current command value 19s outputted from the water-level controller 19 with the load current value detected by and outputted from the load current detector 33, and reference numeral 37 denotes a PWM (pulse width modulation) switching pattern circuit giving, to the inverter 26, a trigger signal C of an optimal PWM switching pattern in response to the output from the comparator 36.

In this embodiment, as described with reference to the first embodiment, the nuclear reactor water-level signal 14s, the main steam flow rate signal 15s and nuclear reactor feed-water flow rate signal 16s (only the reactor water-level signal 14s in the case of the single function control mode) are inputted. The water-level command 17s of the addition/subtraction operator 17 and the detection signal 20s of the reactor water-level set value 20 are compared and controlled, and the signal 9s representing this result is compared, as the current value of the inverter 26, with the current value 33s detected in the comparator 36.

The optimal PWM switching pattern is selected from this result 36s of the comparing operation and the detected value 34s of the revolution speed, and the trigger signal C of the PWM switching pattern is inputted into the inverter 26 as the drive circuit of the semiconductor switching device, thereby performing the ON/OFF control of the semiconductor switching device and then performing the PWM control.

Accordingly, since the output wave-form of the inverter 26 can be made into sine wave t, the power loss due to higher harmonic wave of the feed-water pump drive motor 9M can be reduced, and moreover, by selecting the optimum switching pattern, the power loss due to the switching operation of the semiconductor device can be also reduced.

### Fifth Embodiment

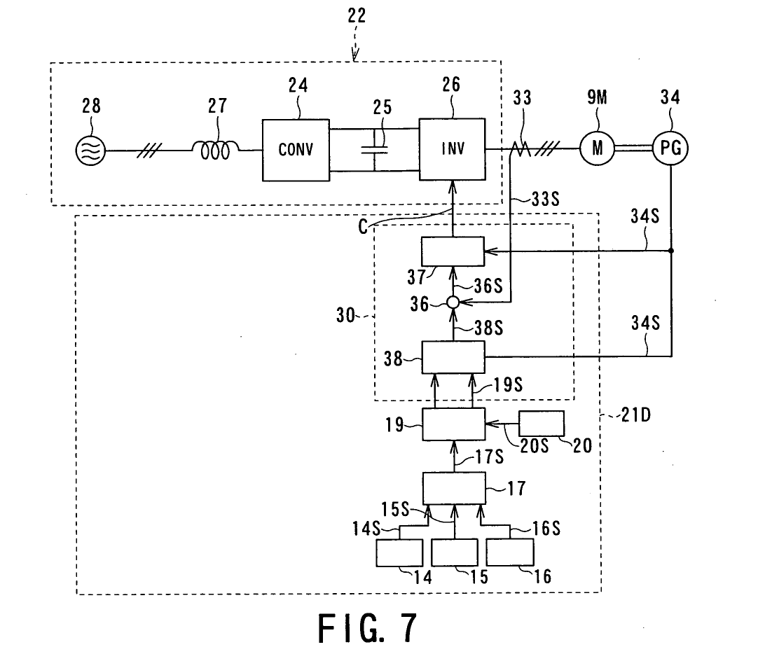

FIG. 7 shows a block diagram representing the nuclear reactor feed-water pump control unit according to the fifth embodiment of the present invention.

With reference to FIG. 7, reference numeral 21D denotes a nuclear reactor feed-water pump control unit, in which the turbine drive feed-water pump speed control circuit 12 is eliminated. In this fifth embodiment, a vector control operator 38 is disposed, in addition to the fourth embodiment mentioned above, between the water-level controller 19 and the comparator 36, and the current command value from the water-level controller 19 and the detected revolution speed value 34s are inputted into this vector control operator 38. The result 38s at this control operation is compared with the detected load current detected value 33s to thereby select the optimum PWM switching pattern, to input the trigger signal C of this PWM switching pattern into the inverter 26 constituting the drive circuit for the semiconductor switching device, and then to perform the PWM control through the ON/OFF control of the semiconductor switching device.

As mentioned above, the controlling performance can be improved by additionally disposing the vector control operator 38, and it becomes possible to carry out the instantaneous value control of the motor 9M to be controlled. Moreover, it becomes possible to perform the motor control instantaneously following up the momentary change of the feed-water flow rate and hence to carry out the stable reactor water feeding.

Further, in this fifth embodiment, in a case of instantaneous operation stop of the power source line side of the semiconductor power conversion circuit 22, the feed-water pump drive motor 9M will take its free-run state. Because of this reason, even if the reactor water feeding command is inputted to the semiconductor power conversion circuit 22, the motor drive feed-water pump 9 cannot be driven and the reactor water-level will be changed.

In order to suppress the influence of such instantaneous operation stop to the nuclear reactor as much as possible, zero-control of the torque current component of the motor 9M during the instantaneous power stop of the vector control circuit 38 is performed, and the excitation current component of the motor 9M is controlled so as to accord with the rated value.

According to such controlling, since the motor 9M can be continuously excited even in the instantaneous power stop, when the power source line side is repaired, the torque controlling of the feed-water pump drive motor 9M can be rapidly and smoothly recovered, and accordingly, the behavior of the motor 9M can be more stabilized to thereby improve the speed follow-up performance thereof.

As a result, the over-shoot amount of the reactor water level 14 with respect to the reactor water-level set value 20 can be made small, and the influence of the instantaneous power stop to the reactor feed-water variation and the reactor water-level variation can be preferably suppressed.

### Sixth Embodiment

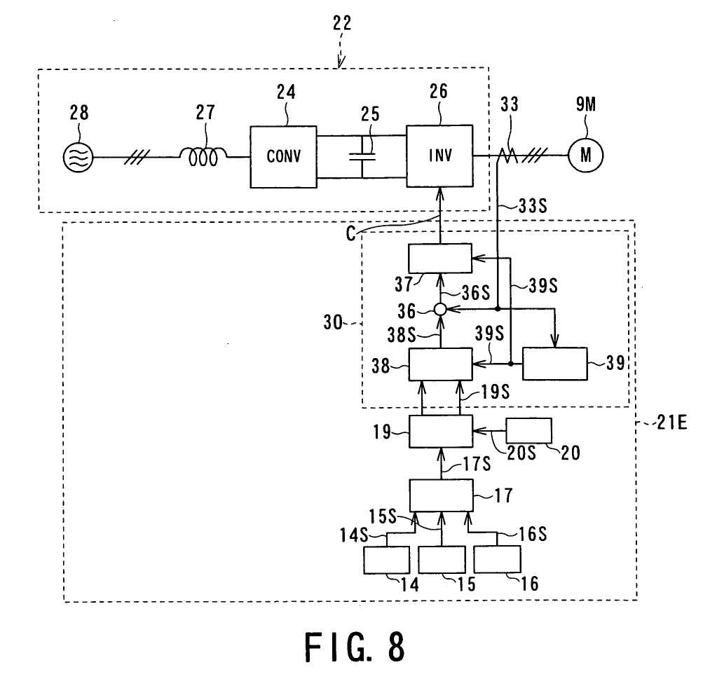

FIG. 8 shows a block diagram representing the nuclear reactor feed-water pump control unit according to the sixth embodiment of the present invention.

With reference to FIG. 8, reference numeral 21E denotes a nuclear reactor feed-water pump control unit, in which the turbine drive feed-water pump speed control circuit 12 is eliminated. This sixth embodiment is includes some changes or modifications in comparison with the fourth or fifth embodiment mentioned above. That is, in the fourth or fifth embodiment, since the revolution speed detector 34 of the fed-water pump drive motor 9M is needed, such revolution speed detector 34 is added to an existing motor equipment.

On the other hand, in this sixth embodiment, as shown in FIG. 8, the revolution speed is estimated, without detecting the revolution number of the feed-water pump drive motor 9M, by a revolution speed operator 39 in response to an inner constant of the motor 9M and the load current value 33s detected by the load current detector 33, and the estimated value 39s is inputted into the PWM switching pattern generator 37 and the vector control operator 38 to thereby perform the vector control (speed sensor-less vector control). In this embodiment, in the estimation of the revolution number, an estimation operating equation is incorporated into the vector control operator 38 and the revolution speed operator 39.

As mentioned above, according to the sixth embodiment, it is not necessary to specifically mount the revolution speed detector 34 to the feed-water pump drive motor 9M, and accordingly, possibility of occurrence of damage or fault can be reduced, and addition of further detectors, lines or like can be eliminated. It is thus possible to achieve substantially the same control performance as that in the former embodiment even without using the revolution speed detector 34.

Furthermore, in this sixth embodiment, as like as in the fifth embodiment, the zero-control of the torque current component of the motor 9M during the instantaneous power stop of the vector control circuit 38 is performed, and the excitation current component of the motor 9M is controlled so as to accord with the rated value.

### Seventh Embodiment

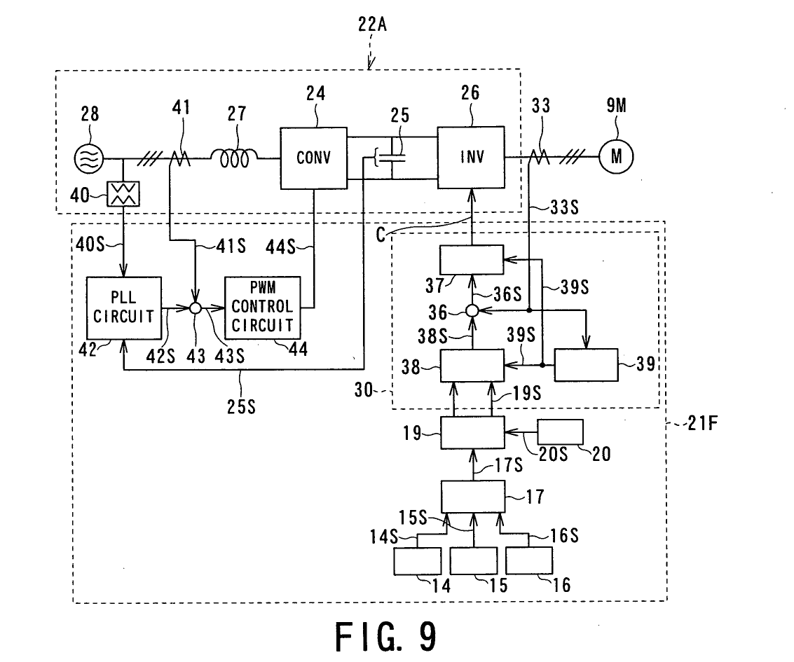

FIG. 9 shows a block diagram representing the nuclear reactor feed-water pump control unit according to the seventh embodiment of the present invention.

This seventh embodiment adopts a three-phase bridge structure by the self-excitation semiconductor switching device as like as the inverter 26 for a converter 24A on the input side of the semiconductor power conversion circuit 22A so as to control the converter 24A with the current command value.

With reference to FIG. 9, reference numeral 21F denotes a nuclear reactor feed-water pump control unit, in which the turbine drive feed-water pump speed control circuit 12 is eliminated. Reference numerals 40 and 41 are voltage detector and current detector respectively for detecting the voltage and current on the power source line side. Reference numeral 42 denotes a phase locked loop (PLL) circuit for preparing current command value 42s from voltage detecting signal 40s and detection voltage 25s of a DC smoothing capacitor 25, and reference numeral 43 denotes an adder correcting the current command value 42s by means of the current detection signal 41s. Reference numeral 44 denotes a PWM control circuit giving a trigger signal 44s to the converter 24A by inputting the corrected current command value 43s through a frequency carrier modulation system or instantaneous current value comparison system.

By constructing the control circuit of the converter 24A in the manner mentioned above, it becomes possible to coincide the input power phase 41s with the source voltage phase 40s, and moreover, since the input current waveform constitutes a sine wave, power factor on the input side can be made “1”.

Accordingly, since the low order high harmonic wave component contained in the power source line side current value 41s can be suppressed, leaking of the high harmonic current to the power source line side can be reduced. In addition, by controlling the power factor on the input side to “1”, reactive power on the input side becomes zero, that is, active power and apparent power indicate the same value, so that the power source capacitor as an equipment of the reactor feed-water pump control unit 21F can be reduced.

### Eighth Embodiment

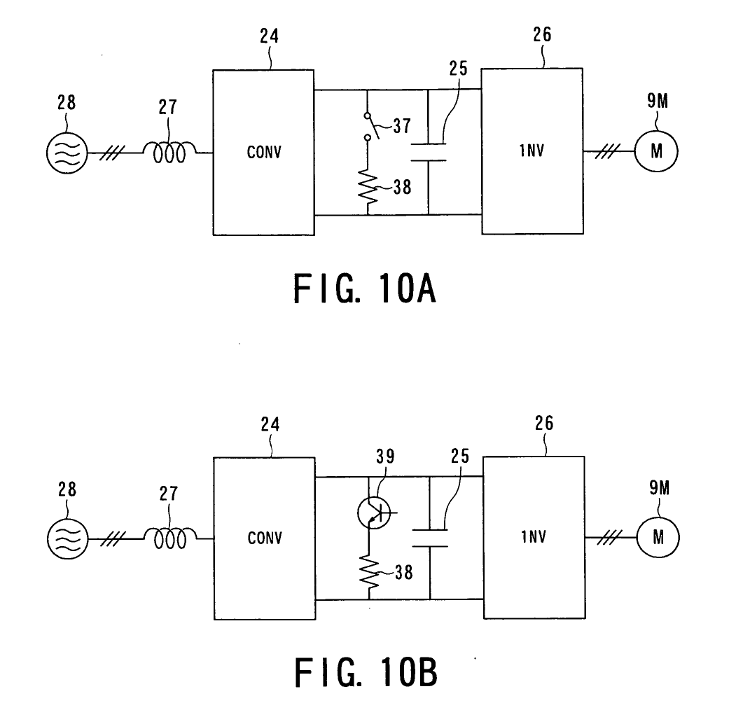

FIGS. 10A and FIG. 10B are diagrams showing structures according to the eighth embodiment of the present invention.

This eighth embodiment, as shown in FIG. 10A, has a structure having the three-phase bridge connection in which the self-excitation semiconductor switching device is also provided for the converter circuit 24 on the input side of the semiconductor power conversion circuit 22 in the circuit arrangement of the first or second embodiment, and also has a structure capable of detecting the voltage and current of the power source line side and the DC smoothing capacitor voltage 25 of the converter. Then, the PLL circuit is constituted by utilizing the detected power source voltage, and the output therefrom is determined as current command, which is compared with the detected current, thus the current control system being constructed. By utilizing such current control system, the converter side PMW control can be realized through the frequency carrier modulation method or current instantaneous value comparison method. According to such control structure, it becomes possible to combine the input current phase with the power source voltage phase, and the input current waveform provides the sine waveform, so that the input side power factor can be made “1”.

Furthermore, it is possible to carry out the shift control so as to shift the input current waveform by 180 degrees with respect to the power source voltage at the time of reducing the operation speed or stopping the operation of the pump drive motor 9M to thereby change the direction of the effective power flow. According to such control structure, since the low mode high harmonic component included in the power source line side current can be suppressed, the leaking of the high harmonic wave current to the power source line side can be effectively reduced. In addition, by controlling the input power factor to “1”, the reactive power becomes zero, and the active power coincides with the apparent power, so that the power capacity as an equipment for the main circuit can be reduced, whereby the regenerative operation for returning the active power to the power source system or line side at the time of speed reduction and stopping operation can be performed as well as the power operation for driving the pump drive motor.

In addition to such regenerative operation, it may be possible to arrange the open/close switch 37 and the discharge resistor 38 between the inverter 26 and converter 24. In this arrangement, when reducing and stopping the operation of the motor 9M without returning the power to the power source line side, the open/close switch 37 is made “ON” so as to allow the discharge resistor 38 to consume the active power at the regenerative time. Further, it may be possible to constitute the open/close switch 37 with the semiconductor switching device 39 such as power transistor. As mentioned above, by additionally disposing the open/close switch 37 and the discharge resistor 38 between the inverter 26 and converter 24, a rectifier (diode bridge circuit) using a diode element can be constituted without using the self-excitation switching device of the converter circuit 24, thus making compact the circuit arrangement and the control arrangement (FIG. 10B).

As mentioned hereinabove, according to the nuclear rector feed-water system of the present invention, the motor can be driven properly in accordance with the feed-water flow rate demand and the hunching, erosion or like in of the feed-water flow rate caused by the arrangement of the flow rate regulating valve can be prevented without consuming the power more than necessity, in comparison with the prior art in which the motor is driven at the rated speed, thus stably controlling the nuclear reactor water level.

What is claimed is:

1. A nuclear reactor feed-water system in which water is fed to a reactor pressure vessel by a reactor feed-water pump, comprising:
a current command value operating unit for comparing a reactor water level setting signal setting a reactor water-level in a reactor pressure vessel with either one of a signal obtained by adding or subtracting a reactor water level detection value, a main steam amount flow rate detection value of a flow rate of the main steam introduced into a steam turbine from the reactor pressure vessel, and a reactor feed-water flow rate detection value of an amount of feed-water fed to the reactor pressure vessel, or reactor water-level detection value, and operating and then outputting a current command value based on comparison result;
a revolution/torque operating unit for operating revolution number command value and toque command value of the reactor feed-water pump in response to the current command value inputted in the revolution/torque operating unit; and
a semiconductor power conversion circuit for supplying power of variable frequency by an inverter with respect to at least one feed-water pump drive motor driving the reactor feed-water pump,
wherein the feed-water drive motor is controlled by giving the revolution umber command value and the torque command value to the inverter to thereby control the feed-water flow rate to the reactor pressure vessel.

2. The nuclear reactor feed-water system according to claim 1, wherein a plurality of feed-water drive motors are arranged, and a control object switching means for selecting an optional feed-water pump drive motors in accordance with the current command value.

3. The nuclear reactor feed-water system according to claim 1, wherein a by-pass line is disposed between inlet side and out side of the motor drive feed-water pump to thereby ensure water-passing in a low-speed area at a motor drive feed-water pump operation start time through the by-pass line.

4. The nuclear reactor feed-water system according to claim 1, further comprising a load current detecting means for detecting a current passing through the feed-water pump drive motor, a revolution number detecting means for detecting revolution numbers of the feed-water pump drive motor, a calculating means for calculating a deviation between the current command value and the load current detection value, and a pulse width modulation switching pattern circuit inputting the deviation and the revolution number detection value, wherein a self-excitation switching device constituting an inverter of the semiconductor power conversion circuit is controlled to be “on” or “off” in response to a signal outputted from the pulse width modulation switching pattern circuit.

5. The nuclear reactor feed-water system according to claim 4, further comprising a vector control operator inputting the current command value and the revolution number detection value, wherein a deviation between an output from the vector control operator and the loaded current is inputted into the pulse width modulation switching pattern circuit, and a self-excitation switching device constituting an inverter of the semiconductor power conversion circuit is controlled to be “on” or “off” in response to a signal outputted from the pulse width modulation switching pattern circuit.

6. The nuclear reactor feed-water system according to claim 5, further comprising a revolution speed operator for calculating a revolution speed by inputting a load current detection value from the pump drive motor, wherein an output of the revolution speed operator is inputted into the vector control operator in place of the revolution number detection value.

7. The reactor feed-water system according to claim 5, wherein the vector control operator serves to zero-control a torque current component of the motor at an instantaneous power stop period of the power source system and to control an excitation current component of the motor to a rated value.

8. The reactor feed-water system according to claim 1, wherein a converter of the semiconductor power conversion circuit is constituted by a self-excitation switching device, and further comprising: a phase locked loop circuit for preparing a current command from a voltage detected from a power source line side of the semiconductor power conversion circuit and a voltage from a DC smoothing capacitor; and a pulse width modulation control circuit for comparing a current detected from the power source line side with a current command value outputted from the phase locked loop circuit.

9. The reactor feed-water system according to claim 1, wherein a low-order higher harmonic wave and a power source capacity are reduced by input side power factor “1” control of the semiconductor power conversion circuit through detection of a power source line side voltage and current in a converter circuit as an input side of the semiconductor power conversion circuit and a DC smoothing capacitor voltage of the converter, and a power supply to a line side at a speed reduction/stop time of the pump drive motor of a load power is enabled in addition to a power supply to the pump drive motor side of the converter circuit, or a regenerative power consumption in the inverter/converter circuit is enabled by controlling the current phase.
